(19) United States
(12) Patent Application Publication
(10) Pub. No.: US 2009/0095157 A1
(43) Pub. Date: Apr. 16, 2009

(54) Smokestack

(76) Inventor: Joseph F. Kirch, Guttenberg, NJ (US)

Correspondence Address: Joseph F. Kirch;The Summit House, 7100 Kennedy Boulevard East, Guttenberg Town, NJ, 07093, US

(21) Appl. No.: 11/879,527

(22) Filed: Oct. 15, 2007

(51) Int. Cl. B01D 46/00

(52) U.S. Cl. 95/273

(57) ABSTRACT

A tube, or duct, is constructed, drawing air from the top of the enclosed structure, or area, through the use of a high speed rotating fan, and filtered. The air is drawn through the tube, or duct, by a second high speed rotating fan to the base of the enclosed structure, where it is filtered a second time, and exhaled back into the enclosed structure. Not only does this process improve air circulation, but also energy efficiency.

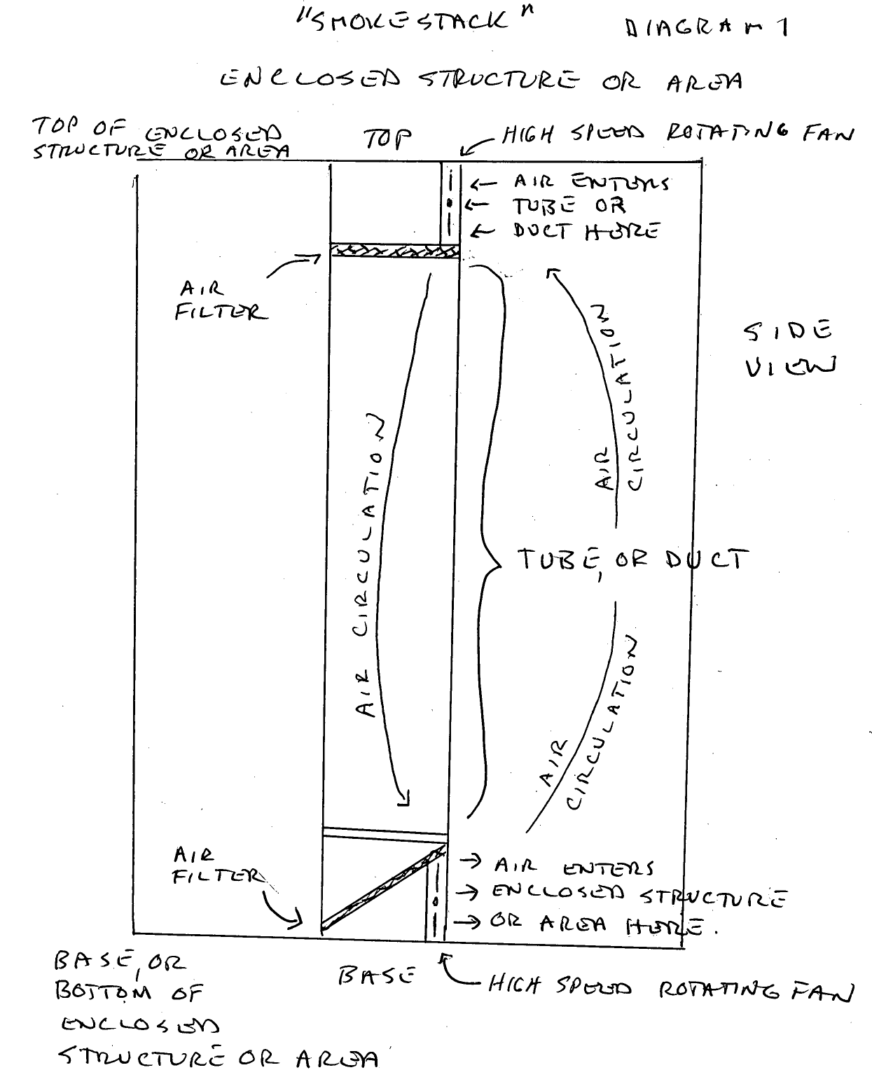

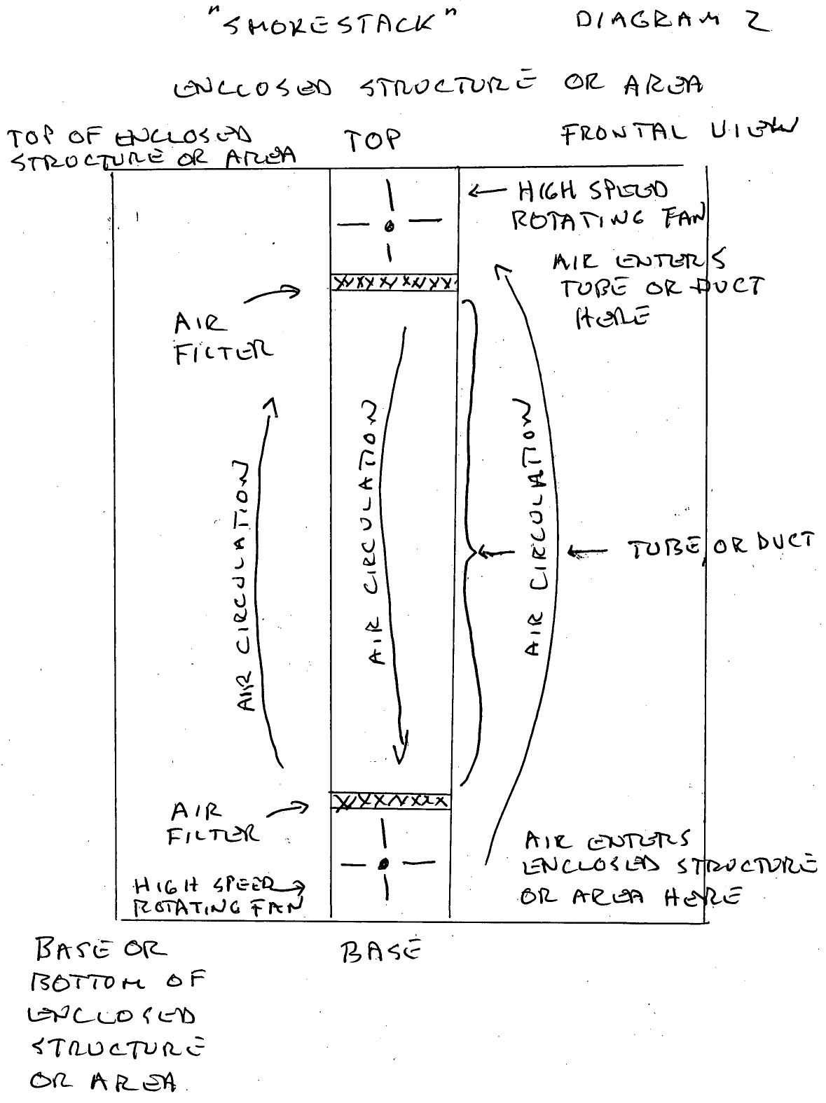

The device inhales air from a point near the top of an enclosed structure or area through the use of a high speed rotating fan, is filtered, and is drawn within a vent, or tube, to a point near the base, or surface, of the enclosed structure or area, where it is filtered a second time, and exhaled through the use of a second high speed rotating fan into the enclosed structure or area.

The size of the device to be constructed is dependent upon the size of the enclosed structure or area.

### CROSS-REFERENCE TO RELATED APPLICATIONS

The Application submitted is based upon adjustments and improvements to current air ventilation technology, and utilizes conventional rotating fan and air filtration technology.

### STATEMENT REGARDING FEDERALLY SPONSORED RESEARCH AND DEVELOPMENT

I suffer from Manic Depression, Paranoid, and Schizophrenia, and am currently on Social Security Disability.

### REFERENCE TO SEQUENCE LISTING, A TABLE, OR A COMPUTER PROGRAM LISTING COMPACT DISC

NA

### APPENDIX

NA

### BACKGROUND OF THE INVENTION

During the winter of 2006, a neighbor came to call. The air in my apartment was fetid, and the neighbor pointed out that instead of opening the lower windows to improve circulation, I might better air my apartment by opening the top portion of the window.

Spurred by this revelation, I expanded upon the idea by purchasing an air filtration device, off the shelf, from a local vendor, which I mounted upon my wall with brackets near the ceiling of the room. The device worked well. Air was filtered at a point near the ceiling.

Later, upon reviewing the device, I decided to expand upon the idea and improve upon the process by creating my own air filtration device, which is the subject of this application, by creating a ventilation tube, or duct, with a high speed rotating fan located at the top of the enclosed structure or area, attached to an air tube, or duct, accompanied by a filter, to draw the air into the tube, or duct, which was then channeled to a point near the surface of the enclosed structure or area, where a second filter was used to filter the air a second time, and a second high speed rotating fan pushed the air back into the enclosed structure or area.

The goal in this instance was to not only to filter the air, but also to improve air circulation and energy efficiency.

### BRIEF SUMMARY OF THE INVENTION

The process involved is this: air is drawn, or inhaled, at a point near the top of an enclosed structure or area by a high speed rotating fan, at which point it is filtered and drawn to the base, or surface, of the enclosed structure or area through a tube, or duct, by a second high speed rotating fan, where it is filtered a second time and pushed, or exhaled, back into the enclosed structure or area, or atmosphere, of the enclosed structure or area.

### BRIEF DESCRIPTION OF THE SEVERAL VIEWS OF THE DRAWING

Please refer to accompany diagrams.

### DETAILED DESCRIPTION OF THE OF THE INVENTION

A tube, or duct, is constructed, from the top to the bottom of an enclosed structure or area. A high speed rotating fan and filter are installed at the top of the enclosed structure or area, and a second high speed rotating fan and filter are installed at the base, or surface, of the enclosed structure or area. Air, inhaled at the top of the enclosed structure or area, is filtered, and channeled through the tube, or duct, to a point at the base, or surface, of the enclosed structure or area, where it is filtered a second time and pushed back, or exhaled, into the enclosed structure or area by a second high speed rotating fan, thus creating and improving circulation, and energy efficiency.

In older versions, air is often filtered or removed at the top of the enclosed structure, and re-injected back into the enclosed structure at the same point, or a similar level, such as at the top of the enclosed structure. In the case of warm air, this may be counter productive, as warm air, filtered, pushes warm air produced within the enclosed structure downward, or mixes with the existing warm air, reducing adequate circulation. A corollary to this is that cold air, re-injected into the enclosed structure or area from a point near the top of the enclosed structure or area may cause a disruption of air circulation.

In another instance, attempts to filter air near the base or surface of the enclosed structure or area, or even midpoint, may filter air within the immediate area, but not be able to adequately filter air that has risen to the top of the enclosed structure or area, reducing proper circulation.

The process I advocate is that by drawing the air into a tube, or duct, at the top of the enclosed structure by a high speed rotating fan, where it is filtered, and then to a point at the base, or surface, of the enclosed structure, greater circulation and greater energy efficiency are achieved. This is the nature of this Utility Process application and improvement claimed upon older conventional technology.

Air is inhaled at the top of the enclosed structure or area and exhaled at the base, or surface of the enclosed structure, or area, greatly improving circulation.

1. I claim and state that the process which I advocate—drawing and filtering air at a point near the top of an enclosed structure or area, channeling it through a tube, or duct, from the top of an enclosed structure or area to the base or surface of an enclosed structure or area, and injecting it back into the atmosphere of the enclosed structure or area at a point near the base or surface of the enclosed structure, where it is filtered a second time—improves air circulation and energy efficiency.
